(19) United States
(12) Patent Application Publication
(10) Pub. No.: US 2013/0063927 A1
(43) Pub. Date: Mar. 14, 2013

(54) LED Backlight Module and Liquid Crystal Display Device

(71) Applicants: Poying Lin, Shenzhen (CN); Jie Ren, Shenzhen (CN)

(72) Inventors: Poying Lin, Shenzhen (CN); Jie Ren, Shenzhen (CN)

(21) Appl. No.: 13/375,580

(22) PCT Filed: Sep. 23, 2011
(86) PCT No.: PCT/CN2011/080138

§ 371 Date: Dec. 1, 2011

(30) Foreign Application Priority Data
Sep. 8, 2011 (CN) 201120336838

(51) Int. Cl. G09F 13/14

(52) U.S. Cl. 362/97.3; 362/97.1

(57) ABSTRACT

The present invention discloses a LED backlight module and a LCD device, wherein said LED backlight module comprises a reflector, multiple LEDs arranged on the reflector and a diffuser plate arranged oppositely to the LEDs; said diffuser plate is provided with multiple uniform-lighting structures. Because the diffuser plate of the LED backlight module of the present invention is provided with the uniform-lighting structures, the distance of light mixing and the light diffusion effect are increased through the reflecting and scattering effects of the uniform-lighting structures. Thus, the direct light backlight module is thinned, the number of LEDs is reduced, and the mura phenomenon is reduced.

### TECHNICAL FIELD

The present invention relates to the field of liquid crystal displays (LCDs), particularly to a light emitted diode (LED) backlight module and a LCD device.

### BACKGROUND

At present, in the backlight module using the direct light LED, the LEDs are the point light sources, and are distributed in the backlight structure in the mode of array arrangement. Because the light sources of the LEDs used in the backlight are distributed in the two-dimensional array mode, both thinning and reducing the Number of LEDs can easily result in two-dimensional mura. At present, most methods for solving the problem of mura are achieved by increasing the thickness of the module to increase the distance of light mixing, but such methods do not meet the requirement of the thinning of displays.

### SUMMARY

The aim of the present invention is to provide a LED backlight module and LCD device thereof with light weight, thin thickness and uniform luminance.

The purpose of the present invention is achieved by the following technical schemes.

A LED backlight module comprises a reflector, multiple LEDs arranged on the reflector, and a diffuser plate arranged oppositely to the LEDs, wherein the diffuser plate is provided with multiple uniform-lighting structures.

Preferably, the light incidence side of the diffuser plate is provided with multiple incident-light surface nodes which are convex in the LED direction to form said uniform-lighting structures. The incident-light surface nodes can reduce the height of light mixing to achieve the aims of solving the problem of mura and thinning.

Preferably, the sizes of said multiple incident-light surface nodes are the same, and the distribution density of said incident-light surface nodes directly over the LEDs is more than the distribution density in other domains. In the direct light backlight design, the LEDs will be brighter in the position directly over the LEDs. Therefore, by adding the distribution density of the incident-light surface nodes in the domain, more lights can be reflected to the reflector for secondary reflection and light mixing. Thus, more uniform luminance can be obtained.

Preferably, the light emergence side of said diffuser plate is provided with inwards concave emergent-light surface microstructures to form said uniform-lighting structures. The layout design of the emergent-light surface microstructures makes the LED light source produce light diffusion effect through the emergent-light surface microstructures, to achieve the purposes of reducing Number of LEDs and reducing light mixing height.

Preferably, the concave parts of each said inwards concave emergent-light surface microstructures are in a multi-surface pyramid shape. This is a specific structure of the emergent-light surface microstructure.

Preferably, said emergent-light surface microstructure is in an inverted pyramid shape. The emergent-light surface microstructure is composed of four triangles; the vertexes of said four triangles converge in the direction of the inside of said diffuser plate; and the bottom sides of said four triangles are sequentially connected to form a rectangle. This is a specific structure of the multi-surface pyramid emergent-light surface microstructure.

Preferably, said four triangles are of the same shape; both ends of each bottom side of said four triangles of the emergent-light surface microstructure are sequentially connected to form a square. There is better consistency in light diffusion of the square multi-surface pyramid emergent-light surface microstructures.

Preferably, the light incidence side of said diffuser plate is provided with outwards convex incident-light surface nodes; the light emergence side of said diffuser plate is provided with inwards concave emergent-light surface microstructures; said incident-light surface nodes and the emergent-light surface microstructures form said uniform-lighting structures together. By combining the advantages of the incident-light surface nodes and the emergent-light surface microstructures, the LED backlight module preferably achieves the purposes of solving the problem of mura, reducing the Number of LEDs, improving the light diffusion effect, and thinning the LED backlight modules.

Preferably, said diffuser plate comprises a first diffuser plate and a second diffuser plate; wherein the second diffuser plate is arranged on the light emergent surface of the first diffuser plate in a stacked mode; wherein said incident-light surface modes are positioned on the light incidence side of said first diffuser plate; and said emergent-light surface microstructures are positioned on the light emergence side of said second diffuser plate. This is a specific structure of the uniform-lighting structures.

A LCD device, said LCD device uses the aforementioned LED backlight module.

Because the diffuser plate of the LED backlight module of the present invention is provided with the uniform-lighting structures, the distance of light mixing and the light diffusion effect are increased through the reflecting and scattering effects of the uniform-lighting structures. Thus, the direct light backlight module is thinned, the number of LEDs is reduced, and the phenomenon of mura is reduced.

### BRIEF DESCRIPTION OF FIGURES

FIG. 1 is the schematic diagram of the embodiment of the single diffuser plate of the present invention;

FIG. 2 is the schematic diagram of the embodiment of two diffuser plates of the present invention; and

FIG. 3 is the schematic diagram of one specific shape of the emergent-light surface microstructures of the present invention.

Wherein: 1. LED; 2. incident-light surface node; 3. emergent-light surface microstructure; 4. diffuser plate; 41. the first diffuser plate; 42. the second diffuser plate; 5. reflector.

### DETAILED DESCRIPTION

The present invention will further be described in detail in accordance with the figures and the preferred embodiments.

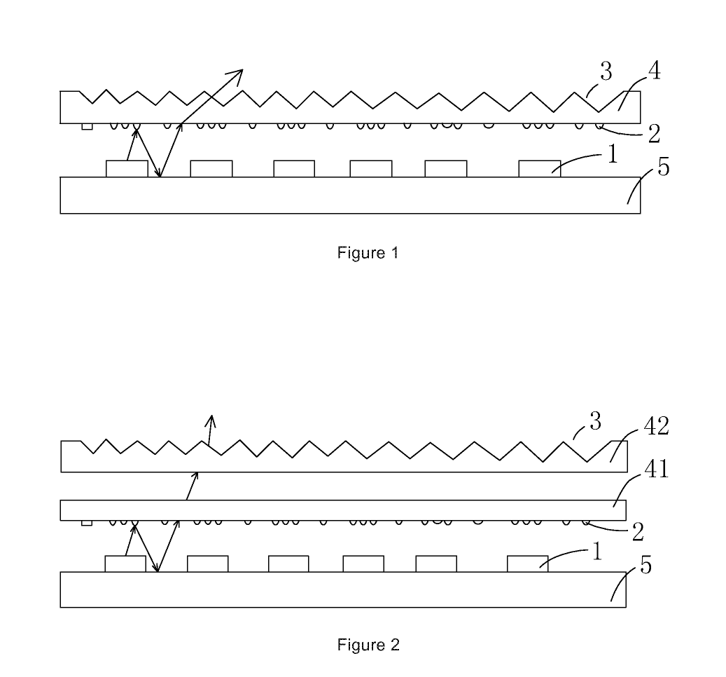

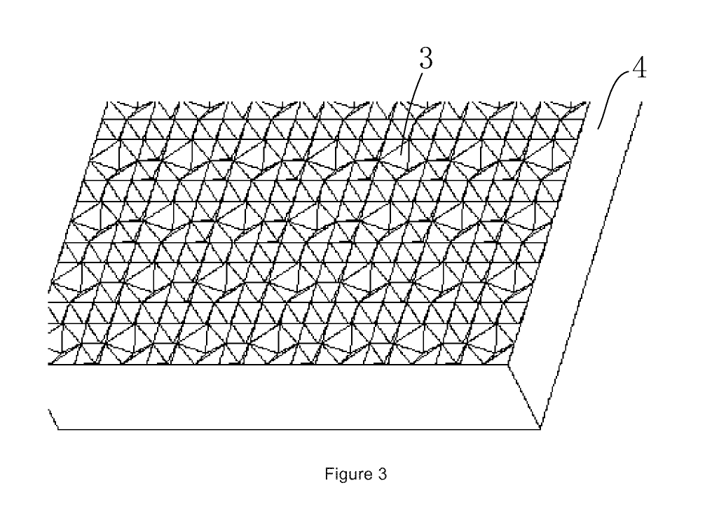

As shown in FIG. 1 to FIG. 3, a LED 1 backlight module of a LCD device comprises a reflector 5, multiple LEDs 1 arranged on the reflector 5, and a diffuser plate 4 arranged oppositely to the LEDs 1, wherein said diffuser plate 4 is provided with multiple uniform-lighting structures.

In order to form said uniform-lighting structures, the light incidence side of the diffuser plate 4 can be provided with outwards convex macroscopic incident-light surface nodes 2, and the structure of each incident-light surface node 2 can reduce the height of light mixing, to achieve the purposes of solving the problem of mura and meeting the requirement of thinning; or the light emergence side of the diffuser plate 4 can be provided with inwards concave macroscopic emergent-light surface microstructures 3, and the layout design of the emergent-light surface microstructures 3 makes the LED 1 light source produce diffusion effect through the emergent-light surface microstructures 3, to achieve the purposes of reducing the number of LED 1 and reducing the height of light mixing. In accordance with the advantages of the incident-light surface nodes 2 and the emergent-light surface microstructures 3, the light incidence side of a piece of diffuser plate 4 can be provided with outwards convex incident-light surface nodes 2, and the light emergence side of the diffuser plate 4 can be provided with inwards concave emergent-light surface microstructure 3. In order to further enhance the effect, the diffuser plate 4 can be divided into a first diffuser plate 41 and a second diffuser plate 42. The light incidence side of said first diffuser plate 41 is arranged oppositely to the LEDs 1; the light incidence side of said second diffuser plate 42 is arranged oppositely to the light emergence side of said first diffuser plate 41; said incident-light surface nodes 2 are positioned on the light emergence side of said first diffuser plate 41; and said emergent-light surface microstructures 3 are positioned on the light emergence side of said second diffuser plate 42.

Preferably, the sizes of said incident-light surface nodes 2 are the same, and the sizes of the incident-light surface nodes can be slightly different to some extent under the same order of magnitude. The distribution density of said incident-light surface nodes 2 directly over the LEDs is more than the distribution density in other domains. The distribution density of said incident-light surface nodes directly over the LEDs 1 is more than the distribution density in other domains. In the direct light backlight design, the LED will be brighter in the position directly over the LEDs. Therefore, more lights can be reflected to the reflector for secondary reflection and light mixing by adding the distribution density of the incident-light surface nodes in the domain. Thus, more uniform luminance can be obtained.

Preferably, each said emergent-light surface microstructure 3 is in a multi-surface pyramid shape. The emergent-light surface microstructure 3 is composed of four triangles; the vertexes of said four triangles converge in the direction of the inside of said diffuser plate 4; and the bottom sides of said four triangles are sequentially connected to forma rectangle. Preferably, said four triangles are of the same shape; both ends of each bottom side of said four triangles of the emergent-light surface microstructure 3 are sequentially connected to form a square. There is better consistency of light diffusion of the square multi-surface pyramid emergent-light surface microstructures 3.

A LCD device, said LCD device uses the aforementioned LED backlight module.

In the direct light backlight design, the LED 1 will be brighter in the position directly over the LEDs 1. In order to solve the problem, the light incidence side of the diffuser plate 4 is provided with some incident-light surface nodes 2 to solve the problem of mura caused by brightness and darkness, and the light emergence side of the diffuser plate 4 is provided with some emergent-light surface microstructures 3. Thus, the LED 1 light source can produce the light diffusion effect through the emergent-light surface microstructures 3 so that the lights are uniform, so as to reduce the mura phenomenon. The principle is that after the LED 1 light source passes through the diffuser plate of the emergent-light surface microstructures 3, the light source can be divided into a plurality of virtual light sources to effectively achieve the light diffusion effect. Combining the above conditions can achieve the purposes of solving the problem of mura, educing the number of LED 1, and reducing the height of the backlight cavity.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A light emitting diode (LED) backlight module, comprising: a reflector, multiple LEDs arranged on the reflector, and a diffuser plate arranged oppositely to the LEDs; said diffuser plate is provided with multiple uniform-lighting structures.

2. The LED backlight module of claim 1, wherein the light incidence side of said diffuser plate is provided with multiple incident-light surface nodes which are convex in the LED direction to form said uniform-lighting structures.

3. The LED backlight module of claim 2, wherein the sizes of said multiple incident-light surface nodes are the same, and the distribution density of said incident-light surface nodes directly over the LEDs is more than the distribution density in other domains.

4. The LED backlight module of claim 1, wherein the light emergence side of said diffuser plate is provided with inwards concave emergent-light surface microstructures to form said uniform-lighting structures.

5. The LED backlight module of claim 4, wherein the concave part of each said inwards concave emergent-light surface microstructure is in a multi-surface pyramid shape.

6. The LED backlight module of claim 5, wherein said emergent-light surface microstructure is in an inverted pyramid shape; the emergent-light surface microstructure is composed of four triangles; the vertexes of said four triangles converge in the direction of the inside of said diffuser plate; and the bottom sides of said four triangles are sequentially connected to form a rectangle.

7. The LED backlight module of claim 6, wherein said four triangles are of the same shape; both ends of each bottom side of said four triangles of the emergent-light surface microstructure are sequentially connected to form a square.

8. The LED backlight module of claim 1, wherein the light incidence side of said diffuser plate is provided with outwards convex incident-light surface nodes, and the light emergence side of said diffuser plate is provided with inwards concave emergent-light surface microstructures; said incident-light surface nodes and the emergent-light surface microstructures form said uniform-lighting structures together.

9. The LED backlight module of claim 8, wherein said diffuser plate comprises a first diffuser plate and a second diffuser plate; wherein the second diffuser plate is arranged on the light emergence surface of the first diffuser plate in a stacked mode; wherein said incident-light surface modes are positioned on the light incidence side of said first diffuser plate; and said emergent-light surface microstructures are positioned on the light emergence side of said second diffuser plate.

10. A liquid crystal displacy (LCD) device, said LCD device uses the LED backlight module of claim 1; said LED backlight module comprises a reflector, multiple LEDs arranged on the reflector, and a diffuser plate arranged oppositely to the LEDs; said diffuser plate is provided with multiple uniform-lighting structures.

11. The LCD device of claim 10, wherein the light incidence side of said diffuser plate is provided with multiple incident-light surface nodes which are convex in the LED direction to form said uniform-lighting structures.

12. The LCD device of claim 11, wherein the sizes of said multiple incident-light surface nodes are the same, and the distribution density of said incident-light surface nodes directly over the LEDs is more than the distribution density in other domains.

13. The LCD device of claim 10, wherein the light emergence side of said diffuser plate is provided with inwards concave emergent-light surface microstructures to form said uniform-lighting structures.

14. The LCD device of claim 13, wherein the concave part of each said inwards concave emergent-light surface microstructure is in a multi-surface pyramid shape.

15. The LCD device of claim 14, wherein said emergent-light surface microstructure is in an inverted pyramid shape; the emergent-light surface microstructure is composed of four triangles; the vertexes of said four triangles converge in the direction of the inside of said diffuser plate; and the bottom sides of said four triangles are sequentially connected to form a rectangle.

16. The LCD device of claim 15, wherein said four triangles are of the same shape; both ends of each bottom side of said four triangles of the emergent-light surface microstructure are sequentially connected to form a square.

17. The LCD device of claim 10, wherein light incidence side of said diffuser plate is provided with outwards convex incident-light surface nodes, and the light emergence side of said diffuser plate is provided with inwards concave emergent-light surface microstructures; and said incident-light surface nodes and the emergent-light surface microstructures form said uniform-lighting structures together.

18. The LCD device of claim 17, wherein said diffuser plate comprises a first diffuser plate and a second diffuser plate; wherein the second diffuser plate is arranged on the light emergence surface of the first diffuser plate in a stacked mode; wherein said incident-light surface modes are positioned on the light incidence side of said first diffuser plate; and said emergent-light surface microstructures are positioned on the light emergence side of said second diffuser plate.
